(19) United States
(12) Patent Application Publication
(10) Pub. No.: US 2016/0371458 A1
(43) Pub. Date: Dec. 22, 2016

(54) METHOD AND SYSTEM FOR ESTIMATION OF EFFECTIVENESS OF A DRUG

(71) Applicant: HITACHI, LTD., Tokyo (JP)

(72) Inventors: Marie Nestor Damian MARIYASAGAYAM, Bangalore (IN); Kenji NAGAMATSU, Bangalore (IN)

(73) Assignee: HITACHI, LTD., Tokyo (JP)

(21) Appl. No.: 15/177,523

(22) Filed: Jun. 9, 2016

(30) Foreign Application Priority Data
Jun. 16, 2015 (IN) 2999/CHE/2015

(51) Int. Cl. G06F 19/00; G06F 17/30

(52) U.S. Cl. CPC G06F 19/3456; G06F 19/326; G06F 19/322; G06F 17/3053; G06F 17/30551

(57) ABSTRACT

Embodiments of the present disclosure relates to a method for estimation of effectiveness of a drug to be administered on a subject. The method comprises steps performed by the estimation server, which involve ranking of one or more medical attributes associated with the subject based on at least one of time parameters and dosage parameters associated with previous subjects. The steps further involve obtaining one or more filtered records from a plurality of records based on the ranking of the one or more medical attributes and a required number of records. Finally the effectiveness of the drug is estimated based on number of the one or more filtered records and predefined time duration.

### TECHNICAL FIELD

The present disclosure generally relates to medical field. Particularly, the present disclosure relates to a method and system for estimating effectiveness of a drug which is to be administered to a subject.

### BACKGROUND

Drugs and dosages of the drugs given to treat a particular disease, disorder and allergy by doctors may not be same for different subjects, i.e. patients. The treatment to each of the subjects may vary with respect to the doctors even though the subjects have similar disease conditions and medical attributes. The doctors also referred as users, estimate the effectiveness of the drugs based on the medical attributes and the disease conditions related to the subjects and make decisions. Various options for treatment of the subjects may give rise to variation in at least one of recovery time, number of drugs, and exposure duration of the subjects to the drug and also may include side-effects on the subjects. In order to reduce the said variations, identification of effectiveness of the drugs also referred as an optimal drug-disease usage is needed.

Presently, Electronic Health Records (EHRs) is gaining popularity and provides immense information is available on record regarding the treatments for one or more disease conditions related to the subjects. The EHRs allows availability of tremendous amount of the records for storage and are readily accessible. In one embodiment, the EHRs contain the drug usage information to treat a particular disease condition of the subject. In order to estimate the effectiveness of the drug, the records that contain drug usage with similar medical attributes of the subjects is analysed. For real-time operations which involve analysing the records is a time consuming process and can slow down the real-time operations that are required for data-centre enabled service.

A conventional system compares target case with a database of records, responsive to proximity between the target case and the database of records to provide records with highest proximity. The proximity is responsive regarding number of attributes which match and number of attributes which differ. Each of the attribute has an attribute value representing index information of the said attribute. The records which are searchable are ordered by the number of attributes, for example the records with lesser number of attributes precede the records which greater number of attributes. In one embodiment, the records are ordered lexicographically by the attribute value, for example, the records with smaller attributes precede the records with larger attributes. The system allows rapid elimination of the records whose proximity cannot match least-best records which are found. The records are examined for attributes which contribute to increased proximity, allowing search specificity improvement by updating the attributes. However, there exists a limitation in the system to provide the records with highest proximity when at least one of the proximity fails to collect sufficient samples and the proximity collects more than required samples.

In another conventional system, capturing, synthesizing, analysing, and reporting drug performance data is disclosed. The conventional system comprises one or more electronic data processors and a data communications interface connected with the one or more electronic data processors. The conventional system is configured for accessing a plurality of databases containing drug analysis and best-practice guidelines, patient data and demographic data. The conventional system also includes a situational modeller configured to execute on the one or more electronic data processor in order to integrate the best-practice guidelines, patient data, and demographic data. Further, the conventional system creates best-practice templates for analysis based upon the integration of the guidelines, patient data, and demographic data and generates a series of reports and analyses to determine drug performance, based upon the analysis. However, the conventional system does not disclose about dynamically adjusting attributes based on attributes and the number of records. Also, the conventional system does not disclose about determining the drug performance based on at least one of time parameters and dosage parameters of the drug which may not determine the drug performance precisely.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Accordingly, the present disclosure relates to a method for estimation of effectiveness of a drug to be administered on a subject. The method comprises steps performed by the estimation server, which involve ranking of one or more medical attributes associated with the subject based on at least one of time parameters and dosage parameters associated with previous subjects. The steps further involve obtaining one or more filtered records from a plurality of records based on the ranking of the one or more medical attributes and a required number of records. Further, the effectiveness of the drug is estimated based on number of the one or more filtered records and predefined time duration associated with the previous subjects.

Further, the present disclosure relates to an estimation server for estimation of effectiveness of a drug to be administered on a subject. The estimation server comprises of a processor and a memory communicatively coupled to the processor. The memory stores processor-executable instructions which, on execution cause the processor to perform steps for estimating the effectiveness of the drug. The steps involve ranking one or more medical attributes associated with the subject based on at least one of time parameters and dosage parameters associated with previous subjects. The steps further involve obtaining one or more filtered records from a plurality of records based on the ranking of the one or more medical attributes and a required number of records. Further, the effectiveness of the drug is estimated based on number of the one or more filtered records and predefined time duration associated with the previous subjects.

The foregoing summary is illustrative only and is not intended to be in any way limiting. In addition to the illustrative aspects and features described above, further aspects, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1a and FIG. 1b illustrates an exemplary embodiment of a system for estimating effectiveness of a drug in accordance with some embodiments of the present disclosure;

FIG. 2 illustrates a flow diagram showing steps performed by an estimation server in accordance with some embodiments of the present disclosure;

FIG. 3a illustrates a flow diagram showing ranking of medical attributes based on time duration of treatment of previous subjects in accordance with some embodiments of the present disclosure;

FIG. 3b illustrates a flow diagram showing ranking of medical attributes based on amount of drug administered to previous subjects in accordance with some embodiments of the present disclosure;

FIG. 3c illustrates a flow diagram showing ranking of medical attributes based on time duration of drug administered associated with previous subjects in accordance with some embodiments of the present disclosure;

FIG. 4 illustrates a flow diagram showing filtering of records using all the medical attributes in accordance with some embodiments of the present disclosure;

FIG. 5 illustrates a flow diagram showing filtering of records by eliminating medical attributes in accordance with some embodiments of the present disclosure;

FIG. 6 illustrates a flow diagram showing filtering of records by using plurality of combinations of medical attributes in accordance with some embodiments of the present disclosure;

FIG. 7 illustrates a flow diagram showing estimation of records based on records selected in predefined time duration in accordance with some embodiments of the present disclosure;

FIG. 8 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific aspect disclosed may be readily utilized as a basis for modifying or designing other structures for carrying out the same purposes of the present disclosure.

In the present document, the word “exemplary” is used herein to mean “serving as an example, instance, or illustration”. Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

The present disclosure relates to a method for estimating effectiveness of a drug to be administered on a subject. The method is performed by an estimation server which includes ranking of medical attributes of the subject, obtaining filtered records from a plurality of records and estimating the effectiveness of the drug. The ranking of the medical attributes is based on time parameters and dosage parameters of previous subjects. Obtaining of the filtered records is based on the ranking of the one or more medical attributes. Further the effectiveness of the drug is estimated based on number of the filtered records and predefined time duration.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

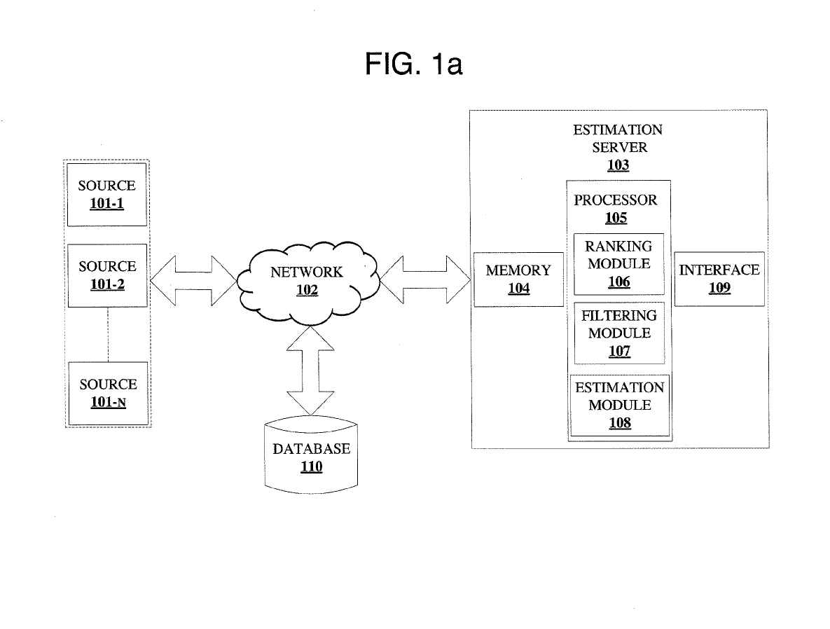

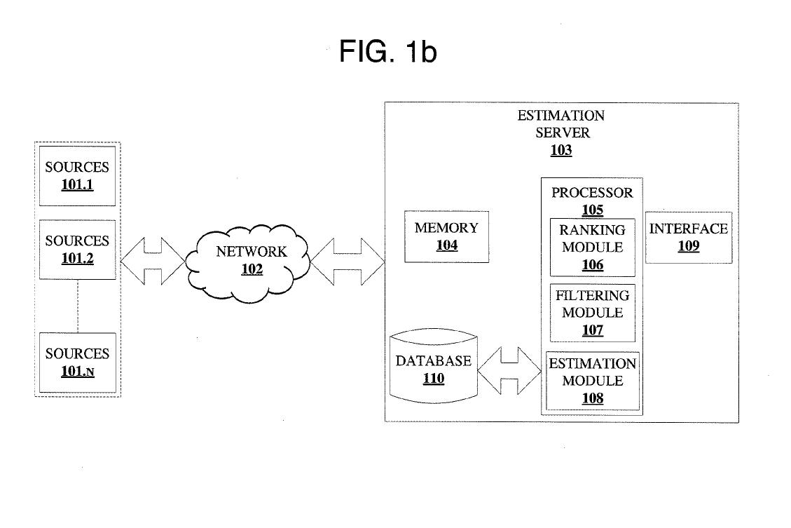

FIGS. 1a and 1b illustrates an exemplary embodiment of a system for estimation of effectiveness of a drug in accordance with some embodiments of the present disclosure.

As illustrated in FIG. 1a, embodiments of the present disclosure comprises of one or more sources 101-1, 101-2 . . . 101-n (collectively referred to as 101), a network 102, an estimation server 103 and a database 110 which are configured to estimate effectiveness of a drug. In one embodiment, the effectiveness of the drug is estimated in real-time. In one embodiment, the effectiveness of the drug is estimated by performing non real-time operations. The one or more sources 101 comprise details about at least one of the drug, the disease associated with the drug and a subject to whom the drug is to be administered. In an embodiment, the details are provided by the sources 101 to the estimation server 103 via the network 102 where the network 102 may be one of wired or wireless. In one embodiment, the one or more sources 101 are hospital servers with data base containing records of the previous subjects. The estimation server 103 comprises of a memory 104, a processor 105 and an interface 109. The memory 104 is communicatively coupled to the processor 105 which comprises of a ranking module 106, a filtering module 107 and an estimation module 108, and stores processor-executable instructions which on execution perform the estimation of effectiveness of the drug. In an embodiment, the database 110 stores records of the plurality of previous subjects obtained from the one or more sources 101 which are filtered to obtain required number of the records. The database 110 is accessed via the network 102 which may be one of wired and wireless. In one embodiment, the database 110 may be present inside the estimation server 103 which provides direct access to the plurality of records of the previous subjects as illustrated in FIG. 1b. In this embodiment, the database can be inside the memory 104 also.

In an embodiment, the ranking module 106 is implemented to rank the medical attributes based on time parameters and dosage parameters associated with the previous subjects. Variance is determined for each of the medical attribute and based on the attribute, the ranking is performed by the ranking module 106.

In an embodiment, the filtering module 107 is implemented to filter the plurality of records to obtain required number of records based on the ranking of the medical attributes. The plurality of records is filtered at each stage of rank of the medical attribute with respect to medical attribute of the subject.

In an embodiment, the estimation module 108 is implemented to estimate the drug effectiveness based on the required number of records obtained from the filtering module and predefine time duration. Functions of each of the ranking module 106, the filtering module 107, and the estimation module 108 are illustrated in detail below.

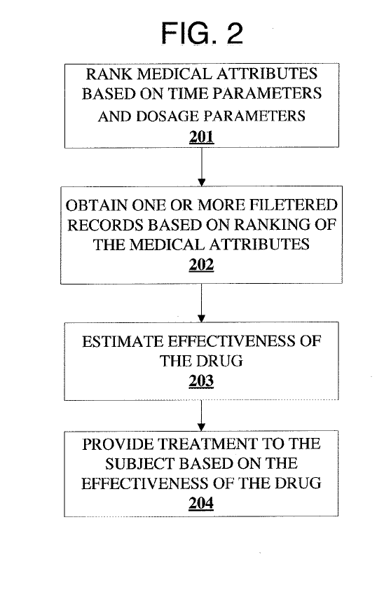

FIG. 2 illustrates a flow diagram showing steps performed by an estimation server in accordance with some embodiments of the present disclosure.

At block 201, rank medical attributes, by the estimation server 103, based on the time parameters and the dosage parameters of the drug associated with the previous subjects. The time parameters comprise at least one of time duration of treatment of the previous subjects and time duration of administration of the drug to the previous subjects. The dosage parameters comprise at least one of amount of drug administered and the time duration of administration of the drug to the previous subjects. The time duration of treatment of the previous subjects is based on admit time and discharge time of the previous subjects. The amount of drug administered to the previous subjects describes amount of drug required to cure the disease associated with the drug. The time duration of administration of the drug describes time taken by the previous subjects to be cured of the disease through administration of the drug for which the effectiveness is to be determined.

At block 202, obtain, by the estimation server 103, one or more filtered records from a plurality of records based on the ranking of the medical attributes. In an embodiment, the one or more filtered records are based on required number of records. The required number may be predefined or may be chosen by one of the user and the doctor depending upon one of the drug and the disease associated with the drug.

At block 203, estimate, by the estimation server 103, effectiveness of the drug based on number of the one or more filtered records and predefined time duration. The number of one or more filtered records is based on records which are related to at least one of admit time, discharge time and both admit and discharge time in the predefined time duration. In one embodiment, the predefined time duration is chosen by one of the user and the doctor.

At block 204, treatment is provided to the subject by the doctor based on the estimated effectiveness of the drug obtained from the estimation server 103.

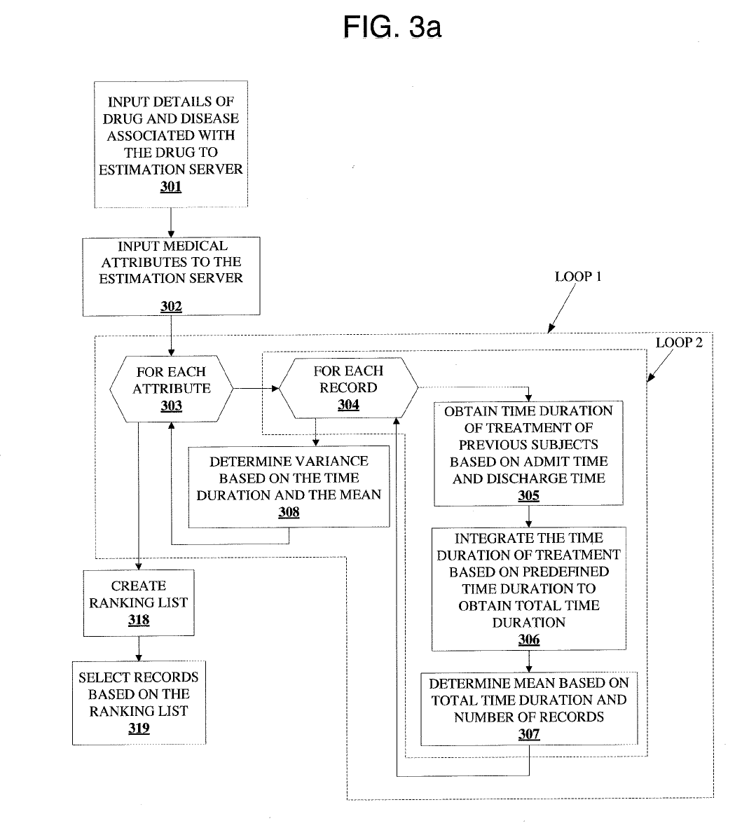

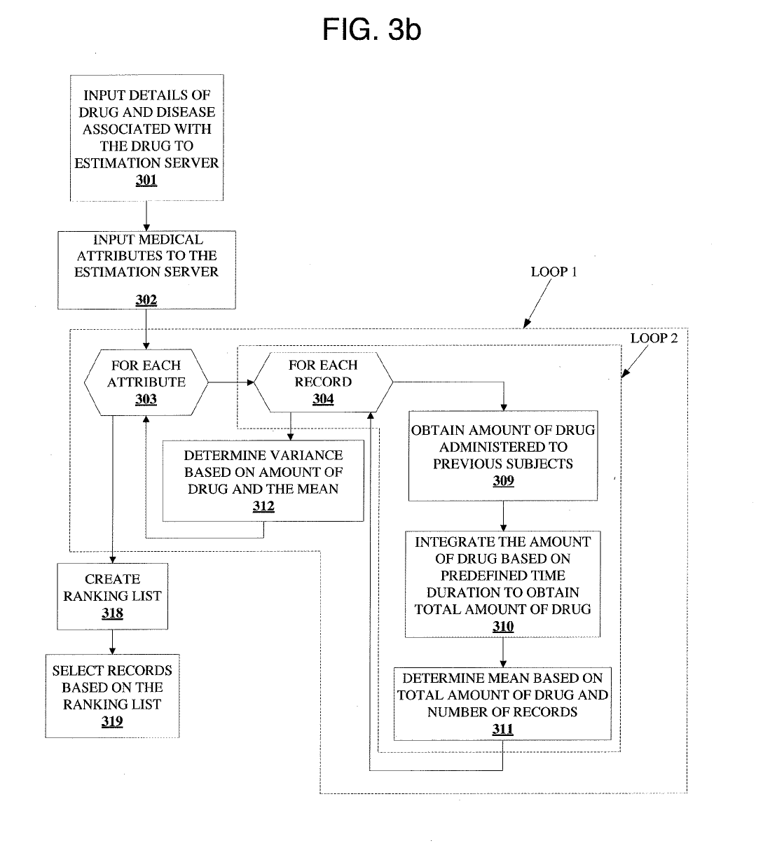

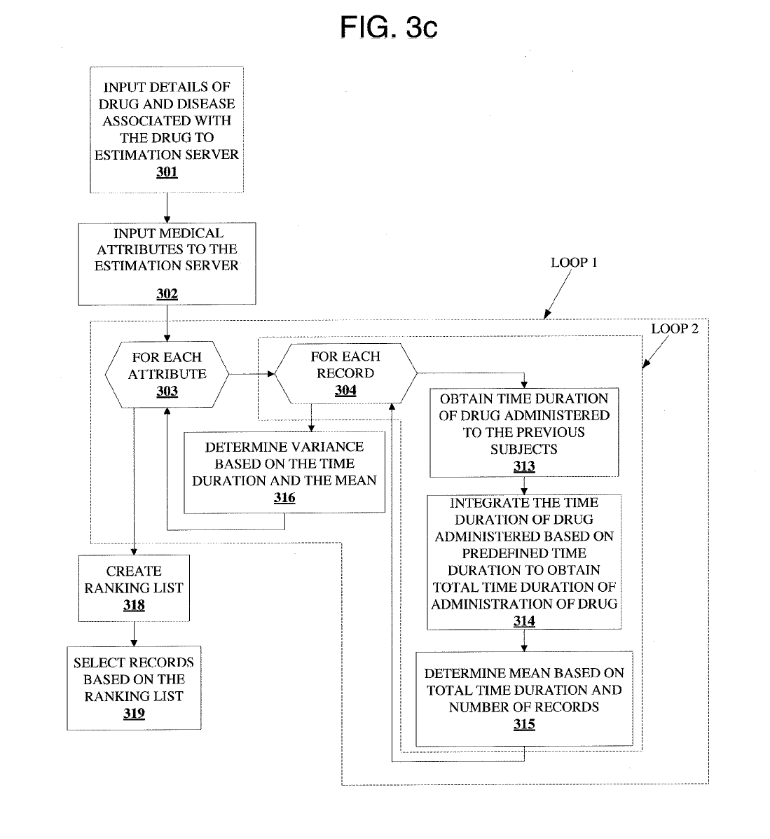

FIG. 3a illustrates a flow diagram showing ranking of medical attributes based on time duration of treatment of previous subjects in accordance with some embodiments of the present disclosure.

FIG. 3b illustrates a flow diagram showing ranking of medical attributes based on amount of drug administered to previous subjects in accordance with some embodiments of the present disclosure.

FIG. 3c illustrates a flow diagram showing ranking of medical attributes based on time duration of drug administered associated with previous subjects in accordance with some embodiments of the present disclosure.

The ranking of the one or more medical attributes associated with the subject is required for filtering the plurality of records. The one or more medical attributes may be age, gender, height, weight, location, occupation, allergy, past illness, family history, physical activities and food habits of the subject. The ranking of the medical attributes describes the importance of each of medical attribute specific to the subject. The ranking of the medical attributes is based on time parameters and dosage parameters associated with the previous subjects. The time parameters include entry and discharge time of the previous subjects which refers to time duration spent by the subject for treatment of the disease associated with the drug. The dosage parameters may include the amount of drug administered to the previous subjects to be cured of the disease. Both, the time parameters and the dosage parameters also include the duration of the drug administered on the subject to cure the disease.

For ranking of the medical attributes, at block 301, input details of one of the drug and the disease associated with the drug to the estimation server 103.

At block 302, input the medical attributes to the estimation server 103. Further, at block 303, loop 1 is executed for each of the medical attribute. At block 304, loop 2 in loop 1 is executed for each of the plurality of records in the database 110.

Further, at block 305, obtain the time duration of treatment of the previous subjects which is based on admit time and discharge time as given in equation 1.

Time duration (X1)=discharge time−admit time 1

At block 306, integrate the time duration (X1) based on the predefined time duration to obtain total time duration (TD) which is given as in equation 2.

Total time duration (TD)=ΣX1 2

At block 307, determine mean (μ1) which is based on total time duration and number of records in the database 110 as given in equation 3.

$$Mean ( μ1 ) = \frac{TD}{N} \qquad 3$$

where N is number of records in the database 110.

After determination of mean for every record in the database 110 in loop 2, at block 308, determine variance based on X1 and μ1 for every attribute in loop 1 as illustrated in FIG. 3. The variance for every corresponding mean of each record for every attribute is given as in equation 4.

Var(X1)=E[X1−μ1] 4

Further as illustrated in FIG. 3b, where the ranking of the medical attributes is based on the amount of drug administered to the previous subjects, at block 309 in loop 2 obtain amount of drug administered to the previous subjects.

At block 310, integrate the amount of drug administered (X2) based on the predefined time duration to obtain total amount of drug (TDA) which is given as in equation 5.

Total amount of drug (TDA)=ΣX2 5

At block 311, determine mean (μ2) which is based on total amount of drug and number of records in the database 110 which is given as in equation 6.

$$Mean ( μ2 ) = \frac{TDA}{N} \qquad 3$$

where N is number of records in the database.

After determination of mean for every record in the database 110 in loop 2, at block 312, determine variance for every attribute in loop 1 as illustrated in FIG. 3. The variance for every corresponding mean of each record for every attribute with respect to the amount of drug administered is given as in equation 7.

Var(X2)=E[X2−μ2] 7

Further as illustrated in FIG. 3c, where the ranking of the medical attributes is based is based on the time duration of administration of drug to the previous subjects, at block 313 in loop 2, determine the time duration of drug administered to the previous subjects.

At block 314, integrate the time duration of treatment (X3) based on the predefined time duration to obtain total time duration of administration of drug (TDD) which is given as in equation 8.

Total time duration of administration of drug (TDD)=ΣX3 8

At block 315, determine mean (μ3) d which is based on total time duration of administration of drug and number of records in the database 110 which is given as in equation 9.

$$Mean ( μ3 ) = \frac{TDD}{N} \qquad 9$$

where N is number of records in the database.

After determination of mean for every record in the database 110 in loop 2, at block 316, determine variance for every attribute in loop 1 as illustrated in FIG. 3. The variance for every corresponding mean of each record for every attribute with respect to the time duration of administration of drug is given as in equation 10.

Var(X3)=E[X3−μ3] 10

At block 318, create ranking list of the medical attributes from least variance to high variance which is obtained by considering at least one of the time duration of treatment (X1), the amount of drug administered (X2) and the time duration of drug administrated (X3). The medical attribute with the least variance is first ranked and the medical attribute with high variance is last ranked. In one embodiment measures which include, but are not limited to, mutual information, correlation may be used for the ranking of the medical attributes. The ranking of the medical attributes as illustrated allows dynamic changing of the sequence of the medical attributes that are required to select the records from the database 110. In one embodiment, combination of variance with other measures such as mutual information and correlation factor may be used for ranking of the medical attributes.

At block 319, select records based on the ranking list from the plurality of records the one or more filtered records from which the effectiveness of the drug is estimated.

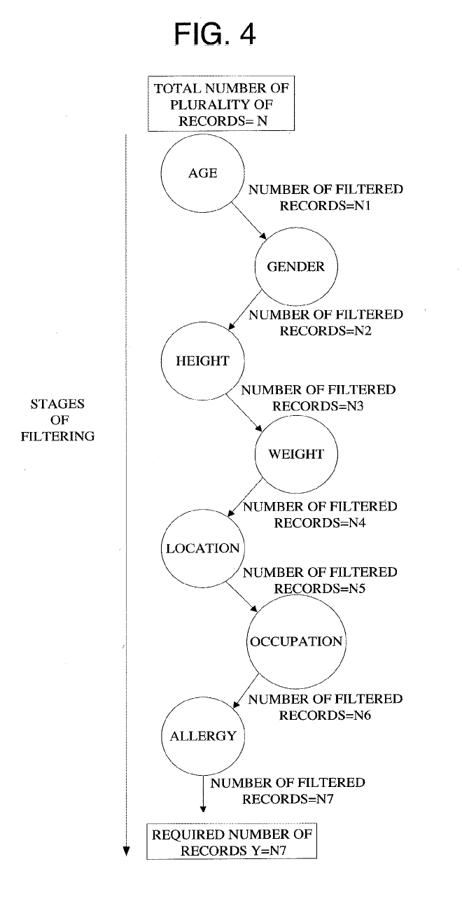

FIG. 4 illustrates a flow diagram showing filtering of records using all the medical attributes in accordance with some embodiments of the present disclosure.

Ranking of the medical attributes based on the variance obtained for each of the medical attribute is illustrated in FIG. 4. Filtering of the plurality of records in the database 110 is performed according to the ranking of the medical attributes. In one embodiment, total number of plurality of records in the database 110 is N and required number of records as specified by subject or doctor is Y. The medical attributes which are considered for filtering are age, gender, height, weight, location, occupation and allergy. The least variance is considered to be first ranked medical attribute that will be used to select the records. As illustrated as an example in FIG. 4, age is ranked first followed by gender, height, weight, location, occupation and allergy of the subject. If the subject is of age 50, then the records falling in between age 40 and 60 are filtered. Further, based on the gender of the subject, that is, if the subject is a female, the records filtered with respect to age are further filtered to obtain female records. The filtering is carried for each of the medical attribute with respect to the subject. As illustrated in FIG. 4, the number of records from filtering with respect to age is N1, number of records from filtering with respect to gender is N2 and number of records from filtering with respect to height is N3. Further, number of records from filtering with respect to weight is N4, number of records from filtering with respect to location is N5, number of records from filtering with respect to occupation is N6 and number of records from filtering with respect to allergy is N7. Overall, the number of filtered records is N7 which is equal to the required number of records ‘Y’ as chosen by one of the doctor and the user.

In one embodiment, in order to eliminate the effect of higher ranked medical attribute on lower ranked medical attributes, the records filtered from the higher ranked medical attributes are discarded. Remaining required number of records can be obtained from the lower ranked medical attributes.

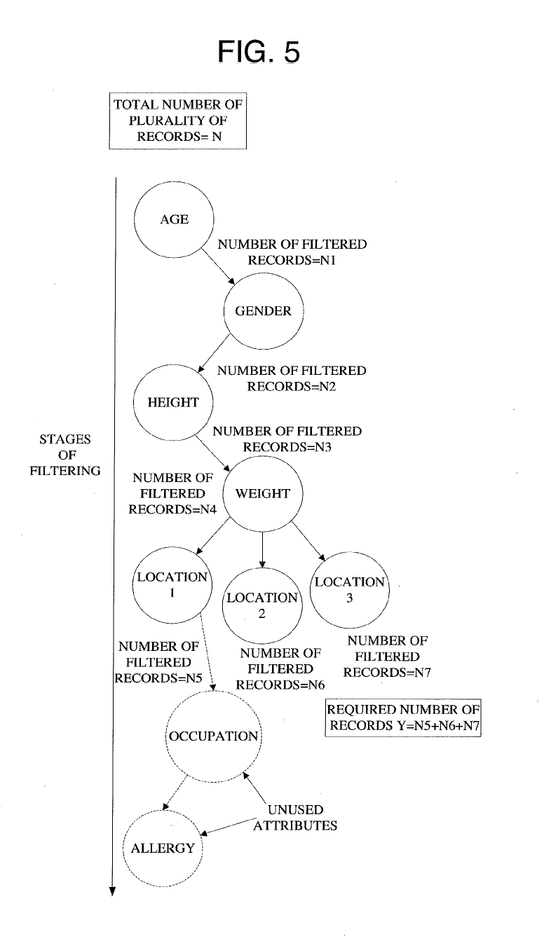

FIG. 5 illustrates a flow diagram showing filtering of records by eliminating medical attributes in accordance with some embodiments of the present disclosure.

When the plurality of records are insufficient to obtain the required number records, the lower ranked attributes may be eliminated. FIG. 5 illustrates one such example for eliminating the lower ranked medical attributes. In one embodiment, the total number of plurality of records is N and number of records from filtering with respect to age is N1, number of records from filtering with respect to gender is N2 and number of records from filtering with respect to height is N3. Further, number of records from filtering with respect to weight is N4 and number of records from filtering with respect to location 1 is N5. In one embodiment, as illustrated in FIG. 5 when N5 is lesser than the required number of records, then additional neighboring location attributes are considered which are location 2 and location 3. Records obtained from location 2 (N6) and records obtained from location 3 (N7) are also considered to obtain the required number of records. Therefore, the required number of records in this embodiment is N5+N6+N7. Since the required number of records is already obtained by considering location 2 and location 3, further filtering may not be performed for the lower ranked attributes which are considered as unused attributes.

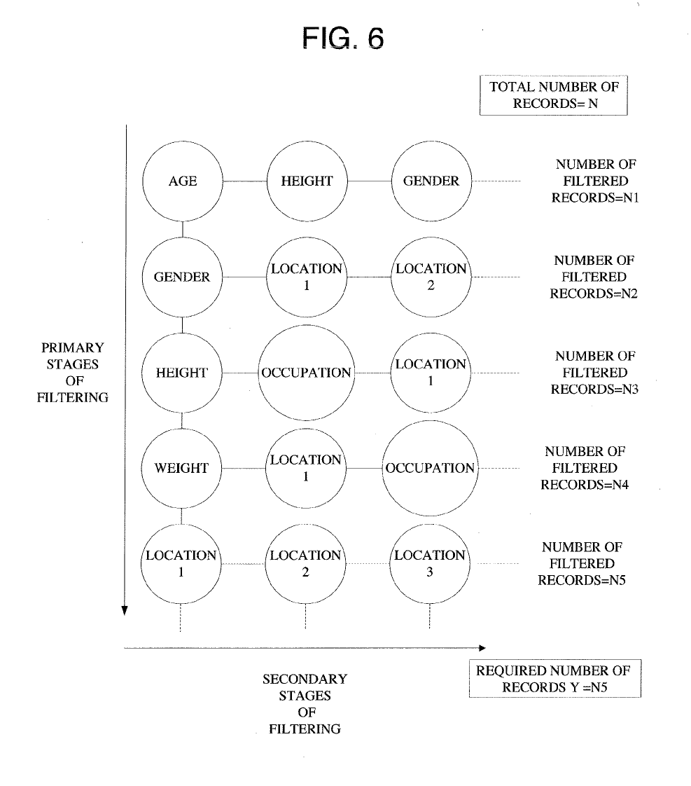

FIG. 6 illustrates a flow diagram showing filtering of records by using plurality of combinations of medical attributes in accordance with some embodiments of the present disclosure.

When the required number of records is insufficient even after filtering with respect of all of the one or more attributes, then combination of plurality of attributes is considered as illustrated in FIG. 6. Secondary stage of the medical attributes is considered to obtain the required number of records. For example as in FIG. 6, when records obtained from location 1 attribute of first stage of the primary stages is not reaching the required number of records then neighboring locations, that are location 2 and location 3 are considered in the secondary stages to obtain sufficient number of records. In FIG. 6 the total number of records is N and number of records filtered at each stage from the higher ranked attributes to the lower ranked attributes is N1, N2, N3, N4 and N5 respectively. The required number of records is N5 obtained from filtering with respect to combination of plurality of medical attributes.

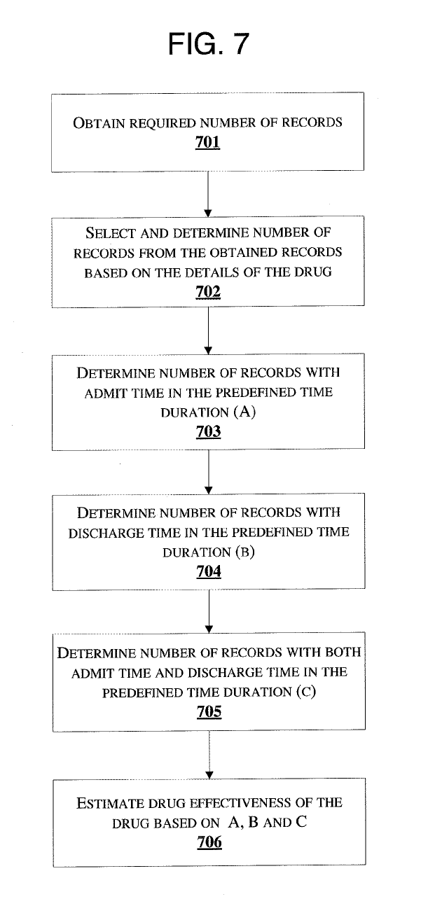

FIG. 7 illustrates a flow diagram showing estimation of records based on records selected in predefined time duration in accordance with some embodiments of the present disclosure;

At block 701, obtain the required number of records after filtering the plurality of records.

At block 702, select and determine number of records from the obtained records based on the details of the drug.

At block 703, determine number of records with admit time in the predefined time duration (A).

At block 704, determine number of records with discharge time (B) in the predefined time duration (B).

At block 705, determine number of records with both admit time and discharge time in the predefined time duration (C).

At block 706, estimate the effectiveness of the drug based on determined A, B and C which is given as in equation 11 and equation 12.

$$\begin{matrix}Alpha = \frac{A + B}{C} & 11 \\ Drug effectiveness = \frac{1}{( Alpha - 1 )} & 12\end{matrix}$$

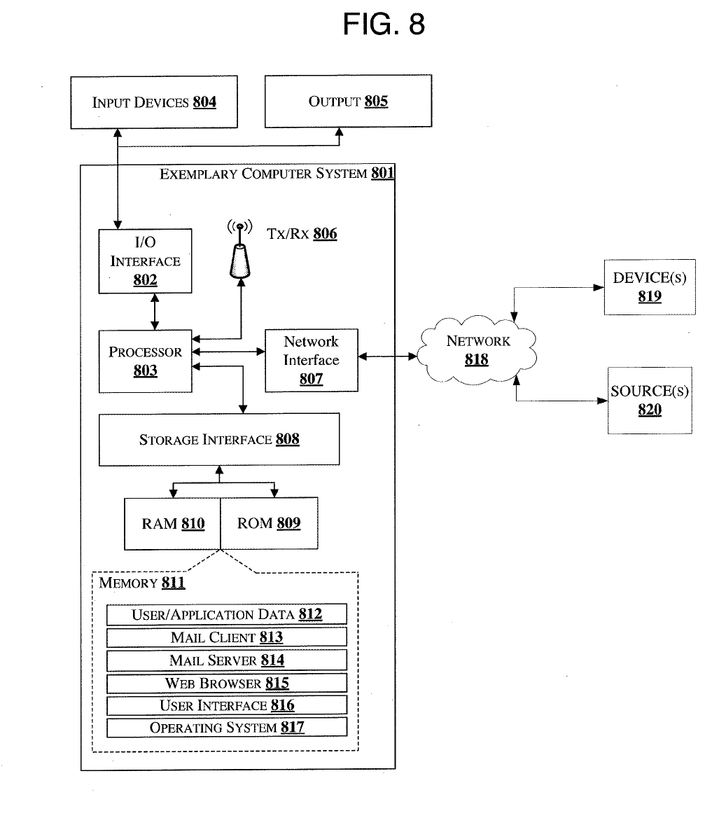

FIG. 8 illustrates a block diagram of an exemplary computer system for implementing embodiments consistent with the present disclosure.

Variations of computer system 801 may be used for implementing all the computing systems that may be utilized to implement the features of the present disclosure. Computer system 801 may comprise a central processing unit (“CPU” or “processor”) 803. Processor 803 may comprise at least one data processor for executing program components for executing user- or system-generated requests. The processor may include specialized processing units such as integrated system (bus) controllers, memory management control units, floating point units, graphics processing units, digital signal processing units, etc. The processor 803 may include a microprocessor, such as AMD Athlon, Duron or Opteron, ARM's application, embedded or secure processors, IBM PowerPC, Intel's Core, Itanium, Xeon, Celeron or other line of processors, etc. The processor 803 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 803 may be disposed in communication with one or more input/output (I/O) devices via I/O interface 802. The I/O interface 802 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 802, the computer system 801 may communicate with one or more I/O devices. For example, the input device 804 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 805 may be a printer, fax machine, video display (e.g., cathode ray tube (CRT), liquid crystal display (LCD), light-emitting diode (LED), plasma, or the like), audio speaker, etc. In some embodiments, a transceiver 805 may be disposed in connection with the processor 803. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 803 may be disposed in communication with a communication network 818 via a network interface 807. The network interface 807 may communicate with the communication network 818. The network interface 807 may employ connection protocols including, without limitation, direct connect, Ethernet (e.g., twisted pair 10/40/400 Base T), transmission control protocol/internet protocol (TCP/IP), token ring, IEEE 802.11a/b/g/n/x, etc. The communication network 818 may include, without limitation, a direct interconnection, local area network (LAN), wide area network (WAN), wireless network (e.g., using Wireless Application Protocol), the Internet, etc. Using the network interface 807 and the communication network 818, the computer system 801 may communicate with sources 820. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 801 may itself embody one or more of these devices.

In some embodiments, the processor 803 may be disposed in communication with one or more memory devices (e.g., RAM 810, ROM 809, etc.) via a storage interface 808. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 811 may store a collection of program or database components, including, without limitation, an operating system 817, user interface application 816, web browser 815, mail server 814, mail client 813, user/application data 812 (e.g., any data variables or data records discussed in this disclosure), etc. The operating system 817 may facilitate resource management and operation of the computer system 801. Examples of operating systems include, without limitation, Apple Macintosh OS X, UNIX, Unix-like system distributions (e.g., Berkeley Software Distribution (BSD), FreeBSD, NetB SD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 816 may facilitate display, execution, interaction, manipulation, or operation of program components through textual or graphical facilities. For example, user interfaces may provide computer interaction interface elements on a display system operatively connected to the computer system 801, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 801 may implement a web browser 815 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 801 may implement a mail server 814 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 801 may implement a mail client 813 stored program component. The mail client may be a mail viewing application, such as Apple Mail, Microsoft Entourage, Microsoft Outlook, Mozilla Thunderbird, etc.

In some embodiments, computer system 801 may store user/application data 812, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

Advantages of the embodiment of the present disclosure are illustrated herein.

In one embodiment, the present disclosure discloses an efficient way to estimate the effectiveness of the drug by analysing records based on previous subjects.

In one embodiment of the present disclosure, the estimation of effectiveness of the drug is done in real-time and estimated values are stored for easy access in order to accelerate real-time operation. The estimation of effectiveness of the drug may be done in non-real-time also.

In one embodiment of the present disclosure, the estimated effectiveness of the drug is accurate.

However a person skilled in art can envisage other application in medical field in which the current disclosure can be used. Further, the instant disclosure can be readily adopted in similar application with minor modification without departing from the scope of the present disclosure.

The terms “an embodiment”, “embodiment”, “embodiments”, “the embodiment”, “the embodiments”, “one or more embodiments”, “some embodiments”, and “one embodiment” mean “one or more (but not all) embodiments of the disclosure(s)” unless expressly specified otherwise.

The terms “including”, “comprising”, “having” and variations thereof mean “including but not limited to”, unless expressly specified otherwise.

The terms “a”, “an” and “the” mean “one or more”, unless expressly specified otherwise. When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The foregoing description of various embodiments of the disclosure has been presented for the purposes of illustration and description. It is not intended to be exhaustive or to limit the disclosure to the precise form disclosed. Many modifications and variations are possible in light of the above teaching. It is intended that the scope of the disclosure be limited not by this detailed description, but rather by the claims appended hereto. The above specification, examples and data provide a complete description of the manufacture and use of the composition of the disclosure. Since many embodiments of the disclosure can be made without departing from the spirit and scope of the disclosure, the disclosure resides in the claims hereinafter appended.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the disclosure of the embodiments of the disclosure is intended to be illustrative, but not limiting, of the scope of the disclosure, which is set forth in the following claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A method for estimation of effectiveness of a drug to be administered on a subject, comprising:
ranking, by an estimation server, one or more medical attributes associated with the subject based on at least one of time parameters and dosage parameters associated with previous subjects;
obtaining, by the estimation server, one or more filtered records from a plurality of records based on the ranking of the one or more medical attributes and a required number of records; and
estimating, by the estimation server, the effectiveness of the drug based on number of the one or more filtered records and a predefined time duration.

2. The method as claimed in claim 1, wherein each of the one or more medical attributes is specific to at least one of disease of the subject and the drug.

3. The method as claimed in claim 1, wherein the one or more medical attributes comprises at least one of age, gender, height, weight, location, occupation, allergy, past illness, family history, physical activities and food habits of the subject.

4. The method as claimed in claim 1, wherein the time parameters associated with the previous subjects comprises at least one of time duration of treatment of the previous subjects and time duration of administration of the drug on the previous subjects.

5. The method as claimed in claim 4, wherein the time duration of treatment of the previous subjects is based on admit time and discharge time of the previous subjects.

6. The method as claimed in claim 4, wherein the dosage parameters associated with the previous subjects is based on at least one of amount of drug administered and the time duration for administration of the drug to the previous subjects.

7. The method as claimed in claim 4, wherein estimating the effectiveness of the drug comprises:
selecting the one or more filtered records where the time duration is within the predefined time duration; and
estimating the effectiveness of the drug based on number of the selected one or more filtered records.

8. The method as claimed in claim 1, wherein the required number of records is provided by one or more sources to the estimation unit.

9. The method as claimed in claim 1, wherein the one or more medical attributes with lower ranking is eliminated when the number of one or more filtered records is equal to the required number of records.

10. The method as claimed in claim 1, wherein plurality of combinations of the one or more medical attributes is used when the one or more medical attributes are insufficient to obtain the number of one or more filtered records equal to the required number of records.

11. An estimation server for estimation of effectiveness of a drug to be administered on a subject, comprising:
a processor; and
a memory communicatively coupled to the processor, wherein the memory stores processor-executable instructions, which, on execution, causes the processor to:
rank one or more medical attributes associated with the subject based on at least one of time parameters and dosage parameters associated with previous subjects;
obtain one or more filtered records from a plurality of records based on the ranking of the one or more medical attributes and a required number of records; and
estimate the effectiveness of the drug based on number of the one or more filtered records and a predefined time duration associated with the previous subjects.

12. The estimation server as claimed in claim 11, wherein each of the one or more medical attributes is specific to at least one of disease of the subject and the drug.

13. The estimation server as claimed in claim 11, wherein the one or more medical attributes comprises of at least one of age, gender, height, weight, location, occupation, allergy, past illness, family history, physical activities and food habits of the subject.

14. The estimation server as claimed in claim 11, wherein the time parameters associated with the previous subjects comprises at least one of time duration of treatment of disease of the previous subjects and time duration of administration of the drug on the previous subjects.

15. The estimation server as claimed in claim 14, wherein the time duration of treatment of the subject is based on admit time and discharge time of the previous subjects.

16. The estimation server as claimed in claim 14, wherein the dosage parameters associated with the previous subjects are based on at least one of amount of drug administered and the time duration for administration of the drug to the previous subjects.

17. The estimation server as claimed in claim 14, wherein estimating the effectiveness of the drug comprises:
selecting the one or more filtered records where the time duration is within the predefined time duration; and
estimating the effectiveness of the drug based on number of the selected one or more filtered records.

18. The estimation server as claimed in claim 11, wherein the required number of records is provided by one or more sources to the estimation unit.

19. The estimation server as claimed in claim 11, wherein the one or more medical attributes with lower ranking is eliminated when the number of one or more filtered records is equal to the required number of records.

20. The estimation server as claimed in claim 11, wherein plurality of combinations of the one or more medical attributes is used when the one or more medical attributes are insufficient to obtain the number of one or more filtered records equal to the required number of records.
